(19) United States
(12) Patent Application Publication
(10) Pub. No.: US 2017/0364869 A1
(43) Pub. Date: Dec. 21, 2017

(54) AUTOMATIC MAINTENANCE FOR AUTONOMOUS VEHICLE

(71) Applicant: Toyota Motor Engineering & Manufacturing North America, Inc., Erlanger, KY (US)

(72) Inventors: Christopher T. Tarte, Ann Arbor, MI (US); Danil V. Prokhorov, Canton, MI (US)

(21) Appl. No.: 15/186,374

(22) Filed: Jun. 17, 2016

(51) Int. Cl. G06Q 10/10; G06Q 50/10

(52) U.S. Cl. CPC G06Q 10/1095; G06Q 50/10

(57) ABSTRACT

A method includes steps of determining, by a computing system of a vehicle, a service center to which the vehicle is to be driven for servicing. The method may further include the steps of, by the computing system, autonomously driving the vehicle from a start location to the service center, and from the service center to a designated end location after servicing.

### TECHNICAL FIELD

The present invention relates to autonomous vehicles and, more particularly, the scheduling of servicing for autonomous vehicles.

### BACKGROUND

Motor vehicles may require regular maintenance in order operate safely and efficiently. In addition, the vehicle may develop problems that would not be detected or addressed during normal maintenance operations. However, the vehicle servicing process may be burdensome for a busy user or owner of the vehicle. The vehicle owner must find a suitable servicing center, schedule vehicle servicing, drive the vehicle to the service center, wait until the servicing is complete, and drive the vehicle back to a home or office. This can take up a large part of a day and may, in some cases, require multiple servicing appointments, depending on the severity of the problem, the availability of parts, and other factors. It may be difficult for busy owners to find the time necessary for vehicle service-related activities.

### SUMMARY

In one aspect of the embodiments described herein, a method includes the step of determining, by a computing system of a vehicle, a service center to which the vehicle is to be driven for servicing.

In another aspect of the embodiments described herein, a computing system for a vehicle is provided. The computing system includes one or more processors for controlling operation of the computing system, and a memory for storing data and program instructions usable by the one or more processors. The one or more processors are configured to execute instructions stored in the memory to determine a service center to which the vehicle is to be driven for servicing.

In another aspect of the embodiments described herein, a non-transitory computer readable medium is provided. The medium has stored therein instructions executable by a computer system to cause the computer system to perform functions, the functions comprising determining, by a computing system of a vehicle, a service center to which the vehicle is to be driven for servicing.

### BRIEF DESCRIPTION OF THE DRAWINGS

FIG. 1 is a schematic block diagram of an autonomous vehicle configured for scheduling vehicle servicing and for driving itself to a service center, in accordance with an embodiment described herein.

FIG. 2 shows one embodiment of a quotation report format presentable in a notification to an owner/user of a vehicle.

FIG. 3 is schematic view of one embodiment of a method for determining a service center for servicing, providing at least one reminder to a user/owner of the vehicle of the scheduled service appointment, and driving the vehicle in for servicing.

FIG. 4 is a block diagram illustrating one embodiment of a method for determining a service center to which a vehicle will be driven for servicing.

FIG. 5 is a block diagram illustrating one embodiment of a method for scheduling vehicle servicing at a selected service center.

### DETAILED DESCRIPTION

Embodiments described herein relate to a vehicle control system or computing system configured to monitor scheduled service dates or milestones for a vehicle, and to determine a service center to which the vehicle will be driven for servicing. The vehicle is configured to communicate with one or more service centers to elicit quotations for service from the service centers prior to the need for servicing. The computing system evaluates the quotations and selects a service center to which the vehicle will be driven for servicing when it is time for servicing. The vehicle may generate at least one notification including a reminder to the vehicle owner/user prior to the scheduled date of servicing. On the date of servicing, the vehicle may autonomously drive itself from its current location to the selected service center, where servicing may be performed. After servicing has been performed, the vehicle may then autonomously drive itself to a designated base location (for example, the home or office of the vehicle owner/user). The vehicle may also be configured to schedule servicing if a problem or malfunction is detected in the vehicle (for example, by vehicle self-diagnostics or prognostics, or by a vehicle sensor) outside of normal maintenance requirements.

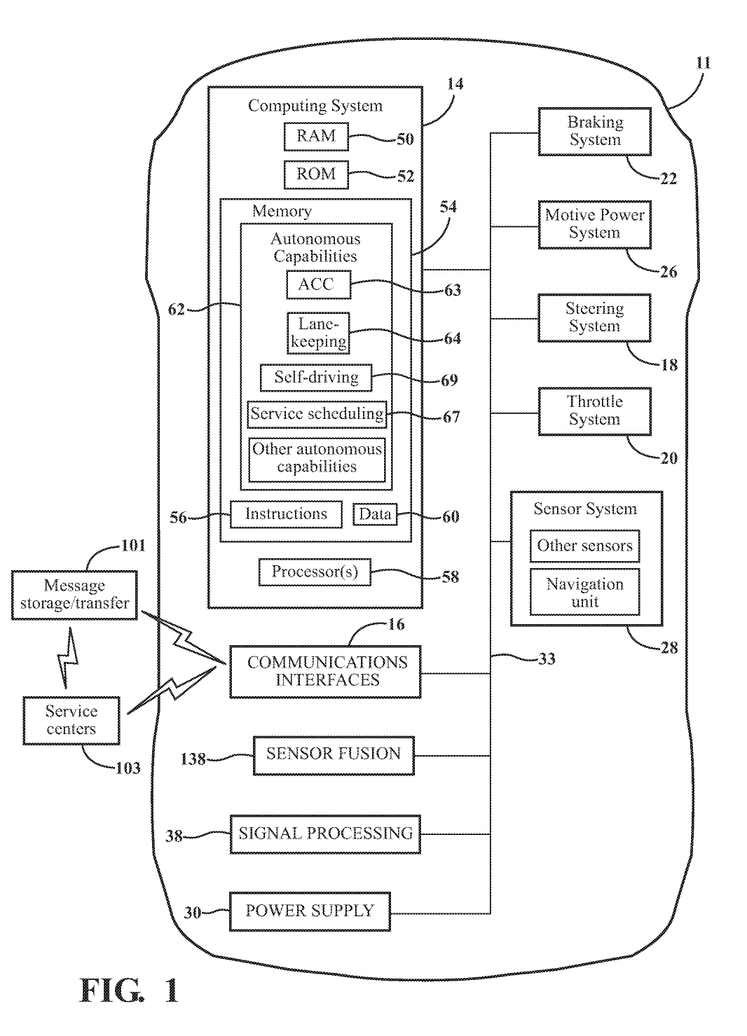

FIG. 1 is a functional block diagram illustrating a vehicle 11 in accordance with an example embodiment. The vehicle 11 may take the form of a car, truck, or any other vehicle capable of performing the operations described herein. The vehicle 11 may be configured to operate fully or partially in an autonomous mode. While in autonomous mode, the vehicle 11 may be configured to operate without human interaction. For example, in an autonomous mode in which an adaptive cruise control (ACC) system is activated, the vehicle may operate the throttle, braking and other systems so as to maintain a safe distance from another vehicle traveling ahead of the vehicle 11, without input from a vehicle occupant. The vehicle 11 may also be configured for completely autonomous driving operations (i.e., for self-driving, without the presence of a driver or driver input) from a start location to a given destination along a route determined by a navigation unit or system, for example.

The vehicle 11 may include various systems, subsystems and components in operative communication with each other, such as a sensor system or array 28, a computing system 14, one or more communications interfaces 16, a steering system 18, a throttle system 20, a braking system 22, a power supply 30, a motive power system 26, and other systems and components needed for operating the vehicle as described herein. The vehicle 11 may include more or fewer subsystems than those shown in FIG. 1, and each subsystem could include multiple elements. Further, each of the subsystems and elements of vehicle 11 may be interconnected. Performance of one or more of the described functions of the vehicle 11 may be executed by multiple vehicle systems and/or components operating in conjunction with each other.

The sensor system 28 can include any suitable type of sensor. Various examples of different types of sensors will be described herein. However, it will be understood that the embodiments are not limited to the particular sensors described.

The sensor system 28 may include a number of sensors configured to sense information about an external environment of the vehicle 11. For example, the sensor system 28 may include a navigation unit such as a Global Positioning System (GPS) and other sensors, for example, an inertial measurement unit (IMU) (not shown), a RADAR unit (not shown), a laser rangefinder/LIDAR unit (not shown), and one or more cameras (not shown) comprising devices configured to capture a plurality of images of the interior of the vehicle and/or an external environment of the vehicle 11. The camera(s) may be still cameras or video cameras. The IMU may incorporate any combination of sensors (e.g., accelerometers and gyroscopes) configured to sense position and orientation changes of the vehicle 11 based on inertial acceleration. For example, the IMU may sense such parameters as vehicle roll rate, yaw rate, pitch rate, longitudinal acceleration, lateral acceleration, and vertical acceleration. The navigation unit may be any sensor configured to estimate a geographic location of the vehicle 11. To this end, the navigation unit may include a one or more transceivers, including a transceiver operable to provide information regarding the position of the vehicle 11 with respect to Earth. The navigation unit may also be configured to determine or plan a driving route from a given start point (for example, a current location of the vehicle) to a selected destination, using stored and/or available maps, in a manner known in the art.

The sensor system 28 may also include sensors configured to monitor internal systems, components, and/or conditions of the vehicle 11 (e.g., an O₂ monitor, a fuel gauge, an engine oil temperature). Other sensors are possible as well. One or more of the sensors included in the sensor system 28 may be configured to be actuated separately or collectively in order to modify a position, an orientation, or both, of the one or more sensors.

In a known manner, the vehicle sensors 28 provide data used by the computing system 14 in formulating and executing suitable control commands for the various vehicle systems. For example, data from inertial sensors, wheel speed sensors, road condition sensors, and steering angle sensors may be processed in formulating and executing a command in steering system 18 to turn the vehicle. Vehicle sensors 28 may include any sensors required to support any driver assistance capabilities incorporated into the vehicle 11. In arrangements in which the sensor system 28 includes a plurality of sensors, the sensors can work independently from each other. Alternatively, two or more of the sensors can work in combination with each other. Sensors of the sensor system 28 can be operatively connected to the computing system 14 and/or any other element of the vehicle 11.

The sensor system 28 may include various types of sensors in communication with other control system components, for providing feedback on operations of the vehicle. For example, sensors 28 may detect and store data corresponding to the vehicle's location (e.g., GPS coordinates), speed and direction, rates of acceleration or braking, and specific instances of sudden acceleration, braking, and swerving.

Additional ones of sensors 28 may detect and store information relating to external driving conditions, for example, external temperature, rain, snow, light levels, and sun position for driver visibility. For example, external cameras and proximity sensors may detect other nearby vehicles, traffic levels, road conditions, traffic obstructions, animals, cyclists, pedestrians, and other conditions that may factor into a driving event data analysis. Additional ones of sensors 28 may detect and store data relating to the maintenance of the vehicle, such as the engine status, oil level, engine coolant temperature, odometer reading, the level of fuel in the fuel tank and/or the battery or electrical power level in a gas-hybrid vehicle, engine revolutions per minute (RPMs), and/or tire pressure.

Any data collected by vehicle sensors 28 may also be transmitted to any vehicle system or component requiring or utilizing the data for the purposes described herein. For example, the data collected by vehicle sensors 28 may be transmitted to computing system 14, or to one or more specialized system or component controllers (not shown). Additional particular types of sensors may include any other types of sensors needed to perform the functions and operations described herein.

Information from particular vehicle sensors may be processed and used to control more than one vehicle system or component. For example, in a vehicle incorporating both automated steering and braking control, various road condition sensors may provide data to the computing system 14 to enable the computing system to process the road condition information in accordance with stored processor-executable instructions, and to formulate appropriate control commands to both the steering system and braking system.

The vehicle 11 may include a suitable signal processing means 38 for situations where a sensor output signal or other signal requires pre-processing prior to use by the computing system 14 or another vehicle system or element, or where a control signal sent from the computing system will require processing prior to use by actuatable sub-systems or sub-system components (for example, components of the steering system or throttle system). The signal processing means may be an analog-to-digital (A/D) converter or digital-to-analog (D/A) converter, for example.

A sensor fusion capability 138 may be in the form of an algorithm (or a computer program product storing an algorithm) configured to accept data from the sensor system 28 as an input. The data may include, for example, data representing information sensed at the sensors of the sensor system 28. The sensor fusion algorithm may process data received from the sensor system to generate an integrated or composite signal (formed, for example, from outputs of multiple individual sensors). The sensor fusion algorithm 138 may include, for instance, a Kalman filter, a Bayesian network, or another algorithm. The sensor fusion algorithm 138 may further provide various assessments based on data from the sensor system 28. In an example embodiment, the assessments may include evaluations of individual objects or features in the environment of the engine module 11, evaluation of a particular situation, and evaluation of possible impacts based on the particular situation. Other assessments are also possible. The sensor fusion algorithm 138 may be stored on a memory (such as memory 54) incorporated into or in operative communication with computing system 14, and may be executed by the computing system in a manner known in the art.

The use of “continuously” when referring to the reception, gathering, monitoring, processing, and/or determination of any information or parameters described herein means that the computing system 14 is configured to receive and/or process any information relating to these parameters as soon as the information exists or is detected, or as soon as possible in accordance with sensor acquisition and processor processing cycles. For example, a failure of a sensor used for automated vehicle control may become known when a test signal transmitted through the sensor produces a negative result, or when the automated system employing the sensor attempts to use the sensor for vehicle control. As soon as the computing system 14 receives data from sensors or information relating to the status of a vehicle component for example, the computing system may act in accordance with stored programming instructions. Similarly, the computing system may receive and process an ongoing or continuous flow of information from sensor system 28 and from other information sources. This information is processed and/or evaluated in accordance with instructions stored in a memory, in a manner and for the purposes described herein.

FIG. 1 illustrates a block diagram of an exemplary computing system 14 according to one or more illustrative embodiments of the disclosure. The computing system 14 may be operatively connected to the other vehicle systems and elements and otherwise configured so as to affect control and operation of the vehicle 11 and its components as described herein. The computing system 14 may be configured to control at least some systems and/or components autonomously (without user input) and/or semi-autonomously (with some degree of user input). The computing system may also be configured to control and/or execute certain functions autonomously and/or semi-autonomously. The computing system 14 may control the functioning of the vehicle 11 based on inputs and/or information received from various subsystems (e.g., motive power system 26, sensor system 28, steering system 18, etc.), from any of the communications interfaces 16, and/or from any other suitable source of information.

The computing system 14 may have some or all of the elements shown in FIG. 1. In addition, the computing system 14 may also include additional components as needed or desired for particular applications. The computing system 14 may also represent or be embodied in a plurality of controllers or computing devices that may process information and/or serve to control individual components or subsystems of the vehicle 11 in a distributed fashion.

The computing system 14 may include one or more processors 58 (which could include at least one microprocessor) for controlling overall operation of the computing system 14 and associated components, and which executes instructions stored in a non-transitory computer readable medium, such as the memory 54. “Processor” means any component or group of components that are configured to execute any of the processes and/or process steps described herein or any form of instructions to carry out such processes/process steps or cause such processes/process steps to be performed. The processor(s) 58 may be implemented with one or more general-purpose and/or one or more special-purpose processors. Examples of suitable processors include microprocessors, controllers, microcontrollers, DSP processors, and other circuitry that can execute software. In the context of this document, a computer-readable storage medium may be any tangible medium that can contain or store a program for use by or in connection with an instruction execution system, apparatus, or device. The processor(s) 58 can include at least one hardware circuit (e.g., an integrated circuit) configured to carry out instructions contained in program code. In arrangements in which there is a plurality of processors 58, such processors can work independently from each other or one or more processors can work in combination with each other. In one or more arrangements, the processor(s) 58 can be a main processor of the vehicle 11. For instance, the processor(s) 58 can be part of an electronic control unit (ECU).

In some embodiments, the computing system 14 may include RAM 50, ROM 52, and/or any other suitable form of computer-readable memory. The memory 54 may comprise one or more computer-readable memories. A computer-readable storage or memory 54 includes any medium that participates in providing data or instructions, which may be read by a computer. Such a medium may take many forms, including, but not limited to, non-volatile media, volatile media, etc. The memory or memories 54 can be a component of the computing system 14, or the memory or memories can be operatively connected to the computing system 14 for use thereby. The term “operatively connected,” as used throughout this description, can include direct or indirect connections, including connections without direct physical contact.

The memory 54 may contain data 60 and/or instructions 56 (e.g., program logic) executable by the processor(s) 58 to execute various functions of the vehicle 11, including those described above in connection with FIG. 1. The memory 54 may contain additional instructions as well, including instructions to transmit data to, receive data from, interact with, or control one or more of the vehicle systems and/or components described herein (for example, motive power system 26, sensor system 28, computing system 14, and the communication interfaces 16). In addition to the instructions 56, the memory 54 may store data such as roadway maps, path information, among other information. Such information may be used by the vehicle 11 and the computer system 14 for route planning and otherwise during the operation of the vehicle 11 in autonomous, semi-autonomous, and/or manual modes.

The computing system 14 may be configured to coordinate control of the various actuatable vehicle systems and components so as to implement one or more autonomous capabilities (generally designated 62), including a service scheduling capability 67 and vehicle control capabilities such as a self-driving capability 69 and/or various autonomous driving assistance capabilities. These autonomous capabilities 62 may be stored in memory 54 and/or in other memories and implemented in the form of computer-readable program code that, when executed by a processor, implement one or more of the various processes, instructions or functions described herein. A driving assistance capability may be defined as a capability which assists a driver in operating the vehicle by performing one or more functions which may be performed by the driver if the capability is absent or deactivated. Examples of driving assistance capabilities include adaptive cruise control (ACC) 63 and lane-keeping 64. A self-driving capability may be defined as an ability of the vehicle to perform all of the driving operations required to autonomously (i.e., without human input or interaction) drive the vehicle from a first or start location to a predetermined destination. In a particular embodiment, the vehicle is configured to autonomously drive itself from a start location to a selected service center, as described herein.

An adaptive cruise control capability 63 may be defined as a cruise control system that automatically adjusts the vehicle speed to maintain a safe distance from vehicles ahead, based in information from onboard vehicle sensors. Thus, responsive to inputs from the vehicle sensors, for example, the computing system 14 may control the throttle system, braking system, motive power system and any other pertinent systems as required to implement the ACC functions. A lane keeping capability 64 may be defined as a system designed to alert the driver when the system detects that the vehicle is about to leave or deviate from a traffic lane. Thus, responsive to inputs from the vehicle sensors, for example, the computing system 14 may control the steering and other pertinent systems as required to implement the lane-keeping functions.

In one or more arrangements, the computing system 14 described herein can incorporate artificial or computational intelligence elements, e.g., neural network, fuzzy logic or other machine learning algorithms. Further, in one or more arrangements, the hardware and/or software elements configured for performing particular functions or operations described herein may be distributed among a plurality of elements and/or locations.

In addition to computing system 14, the vehicle may incorporate additional computing systems and/or devices (not shown) to augment or support the control functions performed by computing system 14, or for other purposes.

Communications interfaces 16 may be configured to allow interaction between the vehicle 11 and external sensors, other vehicles, other computer systems, various external messaging and communications systems (such as a satellite system, a cellular phone/wireless communication system, various vehicle service centers as described herein, etc.) and/or a user. The communications interfaces 16 may be configured to communicate with various message servers or message storage and retrieval entities (generally designated 101 in FIG. 1), for storing messages transmitted to or from the vehicle, service centers, an owner/user and/or other entities. For example, messages directed to the vehicle and not received by the vehicle when the vehicle is turned off, may be stored by entity 101 for retrieval by the computing system 14 when the vehicle is turned on. This aids in conserving vehicle battery power by enabling the vehicle communications interfaces to be deactivated when the engine is off. Alternatively, if desired, the computing system 14 and communications interface features and elements needed for service messaging may be powered by the vehicle power supply 30 or by other means when the engine is off. The computing system 14 may be configured to allow a user to enable this capability through a user interface.

The communications interfaces 16 may include a user interface for providing information to or receiving input from a user of the vehicle 11. For example, the communications interfaces 16 may include a voice/audio interface (not shown) (for example, a microphone and speaker for providing audio input and output), keypad, touch screen, and/or stylus through which a user of the computing system 14 may provide input, and may also include and a video display device (not shown) for providing textual, audiovisual and/or graphical output from the computing system. The computing system 14 may be configured to interpret or process any received audio input as a response to a query or an instruction for the computing system. The user interface may control or enable control of content and the layout of interactive images that may be displayed on the display. A display in the form of a touch screen may provide information to a user of the vehicle 11. The display can be any other suitable type of display. For instance, the display can be a liquid crystal display (LCD), a light emitting diode (LED) display or some other suitable display. In one or more arrangements, the display can be a heads-up display, a display for a navigation system, and/or a display included in an instrument cluster. The display(s) can be provided in any suitable location within the vehicle 11.

Computing system 14 may operate in a networked environment supporting connections to one or more remote computers, such as other computing devices, terminals and/or mobile devices (e.g., mobile phones, short-range vehicle communication systems, vehicle telematics devices and vehicle-to-vehicle communications systems)(not shown). Any other computing systems or devices in the vehicle and any related terminals or devices in operative communication with computing system 14 may include devices installed in vehicles, mobile devices that may travel within vehicles, or devices outside of vehicles that are configured to receive and process vehicle and driving data. Thus, any terminals or devices in communication with the computing system 14 may each include personal computers (e.g., laptop, desktop, or tablet computers), servers (e.g., web servers, database servers), vehicle-based devices (e.g., on-board vehicle computers, short-range vehicle communication systems, telematics devices), or mobile communication devices (e.g., mobile phones, portable computing devices, suitably-configured wearable devices (such as a watchband and the like)(not shown), and may include some or all of the elements described above with respect to the computing system 14. In addition, any of these device embodiments may include a haptic interface or may be configured to provide haptic feedback to a vehicle occupant to inform the occupant of any information or condition which should be communicated to the occupant.

The communications interfaces 16 may also include interfaces enabling communication in a wide area network (WAN), a wireless telecommunications network, and/or any other suitable communications networks. The communication network(s) can include wired communication links and/or wireless communication links. The communication network(s) can include any combination of the above networks and/or other types of networks. The communication network(s) can include one or more routers, switches, access points, wireless access points, and/or the like. In one or more arrangements, the communication network(s) can include Vehicle-to-Everything (V2X) technologies (including Vehicle-to-Infrastructure (V2I) and Vehicle-to-Vehicle (V2V) technologies), which can allow for communications between any nearby vehicle(s), and the vehicle 11 and any nearby roadside communications nodes and/or infrastructure.

When used in a WAN networking environment, the computing system 14 may include (or be operatively connected to) a modem or other means for establishing communications over the WAN, such as network (e.g., the Internet). When used in a wireless telecommunications network, the computing system 14 may include (or be operatively connected to) one or more transceivers, digital signal processors, and additional circuitry and software for communicating with wireless computing devices (not shown) via one or more network devices (e.g., base transceiver stations) in the wireless network. These configurations provide various ways of receiving a constant flow of information from various external sources.

The vehicle 11 may include various actuatable sub-systems and elements in operative communication with computing system 14 and other vehicle systems and/or components, and which are operable responsive to control commands received from the computing system. Various actuatable sub-systems and elements may be controlled manually or automatically (by computing system 14) depending on such factors as a given driving situation, which autonomous driving assistance systems (for example, ACC and/or lane keeping) are activated, and/or whether the vehicle is being driven in a fully autonomous mode.

The steering system 18 may include such elements as the vehicle wheels, rack-and-pinion steering gears, steering knuckles, and/or any other elements or combination of elements (including any computer system-controllable mechanisms or elements) that may be operable to adjust the heading of vehicle 11. The motive power system 26 may include components operable to provide powered motion for the vehicle 11. In an example embodiment, the motive power system 26 may include an engine (not shown), an energy source (such as gasoline, diesel fuel, or a one or more electric batteries in the case of a hybrid vehicle), and a transmission (not shown). The braking system 22 could include any combination of elements and/or any computer system-controllable mechanisms configured to decelerate the vehicle 11. The throttle system may include elements and/or mechanisms (for example, an accelerator pedal and/or any computer system-controllable mechanisms configured to control, for instance, the operating speed of the engine and, in turn, control the speed of the vehicle 11. FIG. 1 shows just a few examples of vehicle sub-systems 18, 20, 22, 26 which may be incorporated into a vehicle. A particular vehicle may incorporate one or more of these systems or other systems (not shown) in addition to one or more of the systems shown.

The power supply 30 may provide power to various components of the vehicle 11 and could represent, for example, a rechargeable lithium-ion or lead-acid battery. In some embodiments, one or more banks of such batteries could be configured to provide electrical power. Other power supply materials and configurations are possible. In some embodiments, the power supply 30 and the energy source (not shown) could be implemented together, as in some all-electric cars.

The vehicle 11 may be configured so that the computing system 14, sensor system 28, actuatable sub-systems 18, 20, 22, 26 and other systems and elements thereof can communicate with each other using a controller area network (CAN) bus 33 or the like. Via the CAN bus and/or other wired or wireless mechanisms, the computing system 14 may transmit messages to (and/or receive messages from) the various vehicle systems and components. Alternatively, any of the elements and/or systems described herein may be directly connected to each other without the use of a bus. Also, connections between the elements and/or systems described herein may be through another physical medium (such as wired connections), or the connections may be wireless connections.

Although FIG. 1 shows various components of vehicle 11 such as computing system 14, memory 54, and communications interfaces 16, as being integrated into the vehicle 11, one or more of these components could be mounted or associated separately from the vehicle 11. For example, memory 54 could, in part or in full, exist separately from the vehicle 11. Thus, the vehicle 11 could be provided in the form of device elements that may be located separately or together. The device elements that make up vehicle 11 could be communicatively coupled together in a wired or wireless fashion.

Embodiments described herein relate to a vehicle control system or computing system configured to monitor scheduled service dates or milestones for a vehicle, and to determine a service center to which the vehicle will be driven for servicing. The vehicle may be configured to communicate with one or more service centers to elicit quotations for service from the service centers prior to the need for servicing. The computing system may evaluate the quotations and select a service center to which the vehicle will be driven for servicing when it is time for servicing. The vehicle may generate at least one notification including a reminder to the vehicle owner/user prior to the scheduled date of servicing. On the date of servicing, the vehicle may autonomously drive itself from its current location to the selected service center, where servicing may be performed. After servicing has been performed, the vehicle may autonomously drive itself to a designated end location (for example, the home or office of the vehicle owner/user). The vehicle may also be configured to schedule servicing if a problem or malfunction is detected in the vehicle (for example, by vehicle self-diagnostics or a vehicle sensor) outside of normal maintenance requirements.

In certain embodiments, the computing system 14 may host (via a user-vehicle communications interface, such as a touchscreen, or a cellular device application) an interactive set-up application enabling a user to pre-specify certain vehicle service quotation parameters. This can minimize the frequency of required interaction between the computing system and he owner/user, for the convenience of the user.

The set-up application may elicit from the user such information as the address of a base location from which a search for available service centers will be conducted; a maximum radius (taken from the base location) within which the search for available service centers will be conducted; desired lead-time (if any) for maintenance milestone notifications and other notifications to the vehicle owner/user; whether the owner/user desires for the computing system to automatically elicit service quotations upon arrival of a lead-time date or maintenance milestone date; and how the vehicle owner/user is to receive notifications or otherwise be informed of alerts (for example, by e-mail, text messaging, automated phone call/voice mail, vehicle HMI/communications interface), and any other desired information pertinent to the service quotation and/or scheduling processes. A vehicle-based interface (such as a touchscreen) or another interface (for example, a cellular device application) may display (or provide access to) an icon or other set-up application access means to enable the user to access and/or change the set-up parameters whenever desired. For example, the user may desire to change the base location from the owner/user's home address to the user's office address.

Defaults may be provided for each of the elements listed in the set-up application, in case the user does not specify a preference. For example, the computing system 14 may be configured to automatically elicit service quotations upon arrival of a lead-time date or maintenance milestone date unless an owner/user specifies that such quotes are not to be automatically elicited. In another example, a default search radius for service centers may be set at 5 miles. The applicable default may be displayed below or adjacent the user entry field so that the owner/user can view and change the default, if desired.

Vehicle embodiments described herein may incorporate a service scheduling capability 67. In certain embodiments of the service scheduling capability, the computing system 14 may be configured to monitor a vehicle maintenance schedule stored in memory 54. The vehicle maintenance schedule may include all of the standard maintenance milestones applicable to the vehicle, based on accumulated mileage, the passage of time, or any other criteria. The schedule may, for example, be the schedule included in the vehicle's owner manual. Maintenance milestones may include such items as, for example, an oil change after every 5000 driving miles, tire rotations at least once a year, and any other items which are part of the standard maintenance schedule for a particular make and model of vehicle.

In certain embodiments of the service scheduling capability, to conserve power, the computing system 14 may be configured to acquire any messages stored in message storage and retrieval entities (such as entity 101) when the vehicle engine is turned on. The computing system 14 may also be configured to process acquired messages and other information and conduct direct or indirect (i.e., through entities 101) communications with service centers and/or an owner/user when the vehicle engine is turned on.

The computing system 14 may be configured to (based on the vehicle maintenance schedule) generate notifications to the vehicle owner of any pending and/or current maintenance milestones. The owner may elect to be notified of any maintenance milestones, update information and/or other information via one or more of e-mail, text, through the vehicle HMI (for example, when the engine is started), a cellular phone application, or via any other available medium. As used herein, the terms “owner” and “user” may refer to the actual owner of the vehicle or any person capable of making decisions relating to vehicle maintenance.

The computing system may be configured to generate the maintenance milestone notification prior to actual occurrence of the milestone, thereby providing a “lead time” for decision making by the owner and also for acquisition of price quotations as described herein, prior to actual occurrence of the milestone. The computing system 14 may be configured to wirelessly or otherwise receive messages from the vehicle manufacturer, maintenance schedule updates, recall notices, etc. (i.e., “update information”) from the vehicle manufacturer, a dealership or other source. The computing system 14 may also be configured to query a server or other information source regarding such update information whenever the vehicle engine is turned on and/or periodically during periods when the vehicle is being driven. When the computing system determines that a maintenance milestone has occurred or that a designated “lead-time” date associated with a maintenance milestone has arrived, the computing system may elicit service quotations from one or more service centers.

In a particular embodiment, the computing system 14 may be configured to initiate the process for determining a service center responsive to detection of a problem or malfunction in the vehicle (for example, by vehicle self-diagnostics or prognostics, or by a vehicle sensor) outside of normal maintenance requirements.

It may be possible to streamline the quotation process considerably in cases where the interaction is between the vehicle and approved service centers. An approved service center is a service center that has been approved by the vehicle manufacturer to service the vehicle. One example of an approved service center may be a certified dealer of the pertinent make and model of the vehicle. Another example may be a private garage or mechanic certified by the vehicle manufacturer as capable of performing the required work. In this case, the communication parameters (such as information to be requested in the quote requests and provided by the service centers) may be standardized to promote process speed and efficiency. For example, the approved service centers and their servers, other computing systems, and related communications devices may be configured to receive and process service quote requests in the most efficient manner, using standardized data formats, communications protocols, and procedures. Parts and labor rates for standard maintenance procedures may be predetermined by each service center and stored to facilitate at least partial automation of the quote request response process. In addition, software updates facilitating processing of quote requests can be downloaded to individual vehicles and implemented in tandem with associated updates at the approved service centers.

The computing system 14 may determine the service centers from which service quotes will be requested. In one embodiment, the computing system may be configured to query a remote manufacturer database or other information source using a wireless or wired connection, to access information (including geographical location, e-mail and phone contact information, etc.) relating to approved and/or non-approved service centers. The computing system may interface with the navigation unit and/or with any other information source for the purposes described herein. The service center information may be updated at a central server, for example, on a continuous basis.

The query may include a user-designated base location (for example, the user's home or workplace) and a predetermined search radius specified by the user or the default radius (for example, 5 miles) from the designated base location. For example, the queried database may be configured to provide the computing system 14 with all approved and/or non-approved service center locations residing within the designated search radius. If no approved and/or non-approved service centers are located within the search radius, the computing system may automatically increase the search radius (for example, in increments of 5 miles) and re-query the manufacturer database. This process may continue until at least one approved and/or non-approved service center is located.

Pertinent service center contact information (for example, text, e-mail, center phone numbers, personal contact information, etc.) may also be acquired for each selected service center option. This information may be stored in an information file provided for quoting purposes, the information may be harvested from the service center website, or the contact information may be acquired form other sources.

A digital quote request may be generated for each of the service centers determined from the service center search. The quote request may provide various types of information to the service center for use in generating the quotation. For example, the computing system 14 may include in the request such information as the vehicle identification number (VIN); vehicle make, model, and year; a description of the maintenance work to be done; owner identification information (such as name, address, phone number, e-mail address, etc.), and other information. For cases where standard maintenance work is to be done based on elapsed time or mileage driven, “canned” or pre-prepared descriptions of the work to be done may be stored in memory for use in preparing the quote request.

For use in generating the quote request, the computing system 14 may also include or be in operative communication with a vehicle diagnostic system or device capable of providing the computing system with standardized trouble codes describing any problems aside from the standard maintenance issues. In the quote request, the computing system 14 may request that the service center provide such information as a recitation of the work to be performed, the estimated (and itemized) total cost of the work to be done, the estimated time required for the work to be done, the next three available service dates days of the week and times when the work on the vehicle may be performed, any additional, updated or necessary service center contact information (including address, phone number, e-mail address, and/or the name of a specific contact person), and any other pertinent information.

The computing system may be configured to structure or format the quote request so that it is presented to a recipient at the service center in a manner facilitating rapid and easy generation of a response. For example, the quote request may be configured to display (for example, on a suitable screen display) a series of fillable fields to the recipient, with prompts provided to aid in entering the requested information in a form easily processed by the computing system. The fields may be filled in by the recipient and the completed response transmitted back (using a designated return link or e-mail address, for example) to the computing system or to a server, memory, or other device accessible by the computing system. Use of the fillable response fields may facilitate extraction (by vehicle computing system 14) of the information needed to evaluate the response and compare the response with other responses.

The quote request may provide prompts guiding the responding service center regarding the formatting of the requested reply information. Alternatively, standard computerized forms including fillable fields may be provided for facilitating communications between the vehicle and the service organizations. Such forms may be integrated into computing systems at the service locations for purposes of answering quote requests as described herein. In certain embodiments, the information requested in the quote requests may be automatically extracted from a memory or determined by the service center computing system, with reference to lookup tables, service scheduling logs, and other information residing on (or accessible by) the service center computing systems. This may enable the service center computing system to automatically gather and format the requested information for transmission to the owner/user.

Generation of the quote request may be done before, after, or simultaneously with determination of the service centers from which service quotes will be requested. The generated quote requests may be transmitted by the computing system to each approved and/or non-approved service center determined to be within the search radius. The computing system 14 may be configured to transmit a follow-up request or a reminder if no response to the first request is received within a predetermined time period (for example, three days). The computing system 14 may be configured to notify the owner/user when quote requests and reminders are transmitted, to inform the user that the automated quotation process is currently in operation. If no response is received from one or more particular service centers after a first transmission and a reminder, the computing system may evaluate the responses that are received. If no responses are received to any of the transmitted quote requests after a first transmission and a reminder, the computing system may notify the owner/user via one or more of e-mail, text messaging, or other user interface of the fact that no responses were received to any of the transmitted quote requests. The owner/user may then proceed as desired (for example, by manually scheduling a service appointment). As part of the notification to the owner/user, the computing system may transmit and/or display the pertinent contact information for the approved and/or non-approved service centers present within the specified search radius.

The computing system 14 may be configured to receive responses to the quote requests. The responses may be received by the vehicle 11 and/or by a message storage and retrieval entity 101 for later access (for example, if the vehicle engine is off during transmittal of the response from the service center).

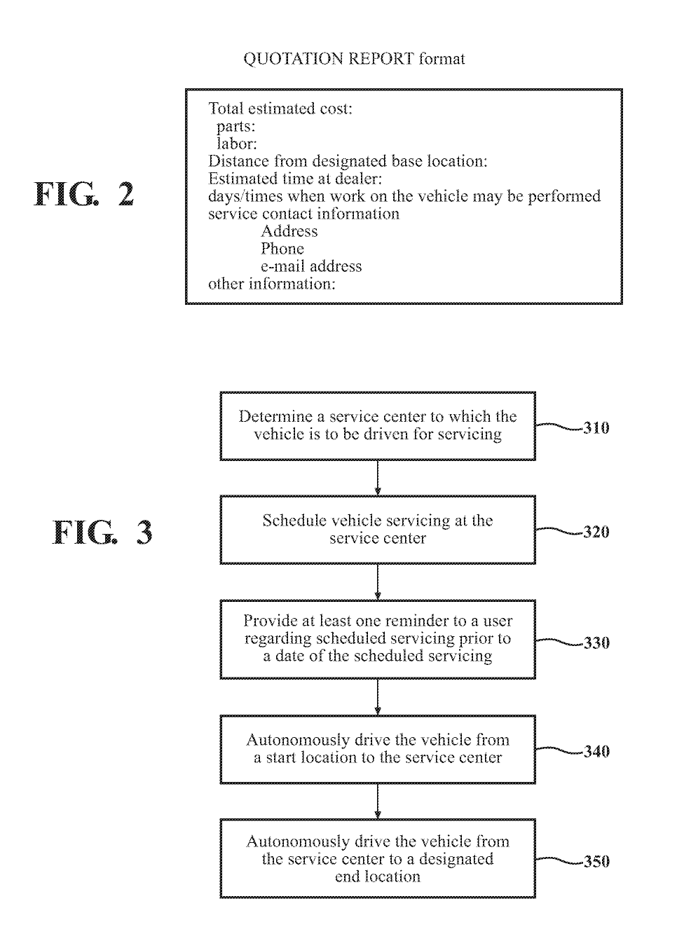

FIG. 2 shows one embodiment of a quotation report format presentable in a notification to the owner/user. The information shown (total estimated cost, distance from base location, etc.) may be presented to the owner/user for each service center which responds to the request for quotation. Alternative presentation formats and/or content may also be used.

After waiting a predetermined time after transmission of the most recently transmitted quote request, the computing system 14 may evaluate any responses received. In evaluating each response, the computing system 14 may extract the pertinent information from the response, using known methods. The computing system may then process the response information using predetermined evaluation criteria. The evaluation criteria may include, for example, a prioritization of the requested quotation information and other parameters, including total cost, time required for the servicing to be performed, distance and/or driving time from the base location to the service center, and other information. The evaluation criteria priorities may be set by the owner/user using the communications interfaces (for example, via an in-vehicle display or a cellular phone application), and default priorities may be assigned for use in cases where the user does not assign a preference.

In addition, the computing system may be configured to interface with the navigation system, the Internet, and/or any other available sources as needed, and to operate to determine an estimated driving time to and from the service center in question. In a particular embodiment, selection of the service center is based on an evaluation of the criterion listed as first or most important. For example, if total cost is the most important criterion, the computing system may select the service center with the lowest quoted total cost for the servicing.

If one or more available service dates and times are not included in a response to a quote request, the computing system may query a user for one or more proposed servicing dates and interact with the selected service center to determine a final servicing date, in the manner described below. If one or more available service dates and times are included in a response to a quote request, the computing device may select one of the dates and times (for example, the first date and time listed) and send a request to the associated service center to schedule servicing for the selected date and time. If the requested date and time are confirmed by the service center, the computing system may then inform the user/owner of the scheduled date and time. If the requested date and time are not confirmed, the computing system may propose another date and time provided on the quote request response. The computing system 14 also may be configured to allow the user/owner to decline the scheduled date and/or time, and to propose and alternative date and/or time. For example, for purposes of specifying a desired date and time, an interactive calendar function may be displayed to the user. A calendar display showing the days of the current month may be presented. This display may be scrollable to show any of the subsequent months. The owner/user may select (using a vehicle touch screen, for example) a day of the month on which he/she wishes the servicing to be performed. Touching the desired day on the screen may result in a display of the hours in the selected day. The owner/user may then select the time period(s) of the selected day in which he/she wishes the work to be performed.

The proposed date and time may be communicated by the computing system 14 to the dealer, as previously described. If the requested date and time are confirmed, the computing system 14 may then inform the user/owner of the scheduled date and time. If the requested date and time are not confirmed, the computing system may propose query the user for another proposed date and time and may convey this proposed date and time to the service center. This process may continue until a service date and time are agreed upon.

The computing system may be configured to generate at least one notification including a reminder to a user regarding scheduled servicing prior to a date of the scheduled servicing. The reminders may be sent via a user-vehicle interface located in the vehicle, by cellular device, by e-mail, or using any other suitable medium. The computing system 14 may be configured to enable user-selection of the medium used for reminder messages. The computing system 14 may also be configured to autonomously drive the vehicle from its current location to the selected service, on the scheduled date and time of servicing. The computing system may be configured to interface with the navigation system, the Internet, or any other available sources as needed to determine the geographical location of the service center where the work is to be performed, and to generate one or more travel routes to the selected service center.

The computing system 14 may be configured autonomously operate the vehicle 11 so as to drive the vehicle from its current location to the service center. U.S. application Ser. No. 14/789,004, the disclosure of which is incorporated herein by reference in its entirety, describes methods and systems usable for controlling an autonomously operable vehicle while traveling from a start location to a designated end location. An autonomous vehicle configured as described in the '004 application may be operatable (in conjunction with the navigation unit or system) to drive to the service center. The computing system 14 may be configured to (responsive to inputs to the navigation system from sensors 28, such as cameras) operate the vehicle 11 in accordance with traffic lights and traffic signs along the planned route and to perform any other operations and functions necessary for self-driving the vehicle to and from the service center. The navigation system and other information sources (for example, real-time traffic information sources) may be accessed to provide information usable by the computing system 14 to calculate a departure time selected to permit the vehicle adequate time to reach the service appointment on time.

The computing system 14 may also be configured to, after servicing, autonomously drive the vehicle from the service center to a designated end location. For example, the service center may provide a notification to the computing system that service has been completed. This notification may trigger a series of commands directed to driving the vehicle to the end location. The route determination and self-driving procedures and systems used to drive the vehicle to the service center may also be used to drive the vehicle to the end location. The end location may be, for example, the start location from which the vehicle was driven to the service center for servicing. This location may be a residence or place of work of the owner/user. Alternatively, the end location may be another location selected by the user. The computing system 14 may be configured to enable the owner/user to select or change an end location at any time prior to or during servicing. The designated base location may serve as a default destination for the vehicle in case no alternative end location is entered, or in case another, preferred location cannot be reached for some reason.

FIG. 3 is schematic view of one embodiment of a method for determining a service center for servicing, providing at least one reminder to a user/owner of the vehicle of the scheduled service appointment, and driving the vehicle in for servicing. Referring to FIG. 3, in block 310, the computing system 14 may determine (using the methods previously described, for example) a service center to which the vehicle is to be driven for servicing. In block 320, the computing system 14 may then schedule vehicle servicing at the selected service center. In block 330, the computing system 14 may provide at least one reminder to a user regarding scheduled servicing prior to a date of the scheduled servicing. In block 340, the computing system 14 may autonomously (without user input or control) drive the vehicle from a start location to the service center when the scheduled date for servicing arrives. In block 350, after servicing is completed, the computing system 14 may autonomously drive the vehicle from the service center to a designated end location.

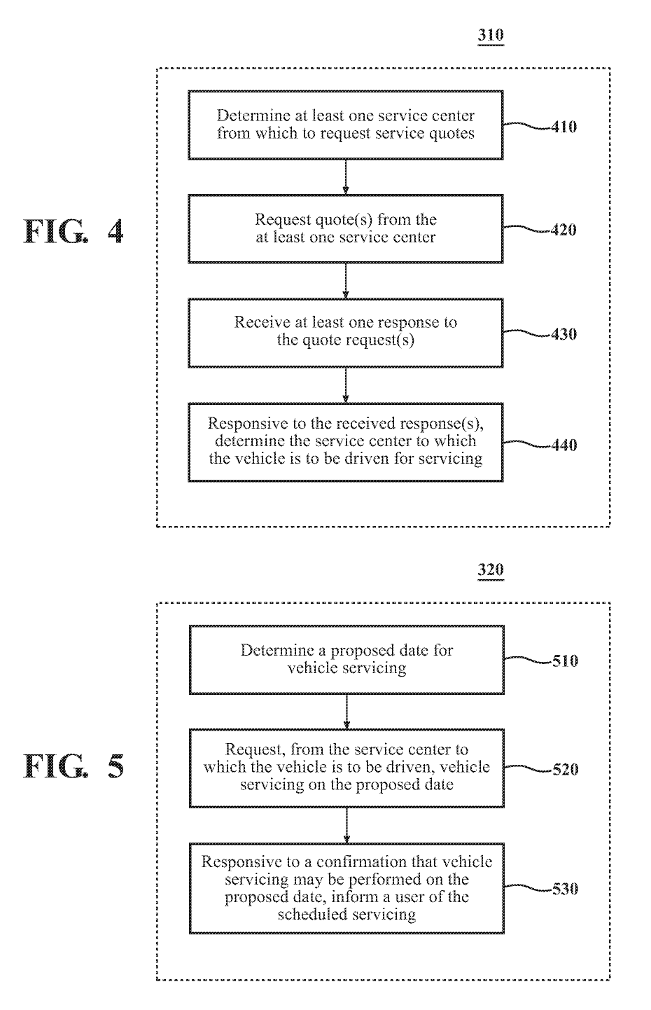

FIG. 4 is a block diagram illustrating one embodiment of a method for determining a service center to which a vehicle will be driven for servicing, as shown in block 310. Referring to FIG. 4, in block 410, the computing system 14 may first determine at least one service center from which to request service quotes. In block 420, the computing system 14 may request quote(s) from the at least one service center. In block 430, the computing system 14 may receive at least one response to the quote request(s) forwarded to the service center(s) in block 420. In block 440, the computing system 14 may, responsive to the received quote request response(s) and using methods previously described or other methods, determine a service center to which the vehicle is to be driven for servicing.

FIG. 5 is a block diagram illustrating one embodiment of a method for scheduling vehicle servicing at a selected service center, as shown in block 320. Referring to FIG. 5, in block 510, the computing system 14 may determine a proposed date and time for vehicle servicing. In block 520, the computing system 14 may request, from the service center to which the vehicle is to be driven, vehicle servicing on the proposed date and time. In block 530, the computing system 14 may, responsive to a confirmation that vehicle servicing may be performed on the proposed date, inform a user of the scheduled servicing.

Also disclosed herein are non-transitory computer readable media with stored instructions. The instructions could be executable by a computing system or device to cause the computing system or device to perform functions similar to those described in the methods described below.

The systems, components and/or processes described above can be realized in hardware or a combination of hardware and software and can be realized in a centralized fashion in one processor or processing system or in a distributed fashion where different elements are spread across several interconnected processors or processing systems. Any kind of processor or processing system or other apparatus adapted for carrying out the methods described herein is suited. A typical combination of hardware and software can be a processor or processing system with computer-usable program code that, when being loaded and executed, controls the processor or processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processor or processing system, is able to carry out these methods.

In addition, various signals representing data, instructions or events as described herein may be transferred between a source and a destination in the form of electromagnetic waves traveling through signal-conducting media such as metal wires, optical fibers, and/or wireless transmission media (e.g., air and/or space).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

1. A method for determining, by a computing system of a vehicle, a service center to which the vehicle is to be driven for servicing, the method comprising steps of:
determining at least one service center from which to request at least one service quote;
requesting at least one quote from the at least one service center;
receiving at least one response to the at least one quote request; and
responsive to the at least one received response, determining the service center to which the vehicle is to be driven for servicing.

2. (canceled)

3. The method of claim 1 wherein the step of determining at least one service center from which to request service quotes comprises the step of, by the computing system, determining service centers within a predetermined radius of a base location.

4. The method of claim 1 further comprising the step of scheduling, by the computing system, vehicle servicing at the service center to which the vehicle is to be driven for servicing.

5. The method of claim 4 further comprising the step of generating, by the computing system, at least one notification including a reminder regarding scheduled servicing prior to a date of the scheduled servicing.

6. The method of claim 4 wherein the step of scheduling comprises the steps of, by the computing system:
determining a proposed date for vehicle servicing;
requesting, from the service center to which the vehicle is to be driven, vehicle servicing on the proposed date; and
responsive to a confirmation that vehicle servicing may be performed on the proposed date, informing a user of the scheduled servicing.

7. The method of claim 1 further comprising the step of, by the computing system, autonomously driving the vehicle from a start location to the service center to which the vehicle is to be driven for servicing.

8. The method of claim 7 further comprising the step of, by the computing system, autonomously driving the vehicle from the service center to a designated end location.

9. A computing system for a vehicle, the computing system comprising one or more processors for controlling operation of the computing system, and a memory for storing data and program instructions usable by the one or more processors, wherein the one or more processors are configured to execute instructions stored in the memory to:
determine a service center to which the vehicle is to be driven for servicing; and
schedule vehicle servicing at the service center to which the vehicle is to be driven for servicing.

10. (canceled)

11. The system of claim 9 wherein the one or more processors are configured to execute instructions stored in the memory to generate at least one notification including a reminder regarding scheduled servicing prior to a date of the scheduled servicing.

12. The system of claim 9 wherein the one or more processors are configured to execute instructions stored in the memory to:
determine a proposed date for vehicle servicing;
request, from the service center to which the vehicle is to be driven, vehicle servicing on the proposed date; and
responsive to a confirmation that vehicle servicing may be performed on the proposed date, inform a user of the scheduled servicing.

13. The system of claim 9 wherein the one or more processors are configured to execute instructions stored in the memory to:
determine at least one service center from which to request service quotes;
request quote(s) from the at least one service center;
receive at least one response to the quote request(s); and
responsive to the received response(s), determine the service center to which the vehicle is to be driven for servicing.

14. The system of claim 13 wherein the one or more processors are configured to execute instructions stored in the memory to determine service centers within a predetermined radius of a base location.

15. The system of claim 9 wherein the one or more processors are configured to execute instructions stored in the memory to autonomously drive the vehicle from a start location to the service center to which the vehicle is to be driven for servicing.

16. The system of claim 15 wherein the one or more processors are configured to execute instructions stored in the memory to autonomously drive the vehicle from the service center to a designated end location.

17. A non-transitory computer readable medium having stored therein instructions executable by a computer system of a vehicle to cause the computer system to perform functions, the functions comprising:
determining at least one service center from which to request at least one service quote;
requesting at least one quote from the at least one service center;
receiving at least one response to the at least one quote request; and
responsive to the at least one received response, determining a service center to which the vehicle is to be driven for servicing.

18. The non-transitory computer readable medium of claim 17 wherein the functions further comprise autonomously driving the vehicle from a start location to the service center.

19. The non-transitory computer readable medium of claim 18 wherein the functions further comprise autonomously driving the vehicle from the service center to a designated end location.

20. The non-transitory computer readable medium of claim 17 wherein the functions further comprise scheduling vehicle servicing at the service center to which the vehicle is to be driven for servicing.
